(19) United States
(12) Patent Application Publication
(10) Pub. No.: US 2008/0196068 A1
(43) Pub. Date: Aug. 14, 2008

(54) PORTABLE MULTIMEDIA DEVICE

(75) Inventor: Chao-Hsien Tseng, Taoyuan (TW)

Correspondence Address: LAW OFFICES OF MIKIO ISHIMARU, 333 W. EL CAMINO REAL, SUITE 330, SUNNYVALE, CA, 94087, US

(73) Assignee: MITAC INTERNATIONAL CORPORATION, Taoyuan (TW)

(21) Appl. No.: 11/852,285

(22) Filed: Sep. 8, 2007

(30) Foreign Application Priority Data
Feb. 9, 2007 (TW) 096104740

(51) Int. Cl. H04N 7/16

(52) U.S. Cl. 725/62

(57) ABSTRACT

A portable multimedia device capable of remotely controlling and receiving TV signals transmitted from a display device using a wireless transmission function thereof is disclosed. The portable multimedia device includes of: a transmission interface, a display unit, a page-dividing unit and a selecting unit. The page-dividing unit allows the user to set the number of the desired channels for preview, and further divides the picture shown on the display unit into a plurality of sub-pictures. The selecting unit allows the user to select the desired channels according to the plurality of sub-pictures, and further displays the desired channels on the display device or the display unit, thereby providing at least two different channels thereon for users' preview and view as desired.

### BACKGROUND OF THE INVENTION

1. Field of the Invention

The present invention relates to a portable multimedia electronic device, and more particularly, to a portable multimedia electronic device capable of remotely controlling and receiving TV signals transmitted from a display unit via a wireless transmission function provided thereof.

2. General Background

With the prevalence of wide-band network transmission, conventional digital televisions having single functionality no longer satisfy consumers' escalating demands for versatile and highly interactive functionality. As such, modern digital televisions typically possess the characteristics of high integration and easy operation in order to combine with comprehensive digital services available nowadays.

Thanks to the advancement of modern technologies, a multitude of TV channels are available nowadays for viewers' selection. Often, it is desirable to watch more than one channel at a time in an environment or a household where more than one person is gathered in a single room watching TV.

Therefore, it is desirable to develop a portable multimedia device that can provide more than one channel for viewers' selection as desired.

### SUMMARY OF THE INVENTION

In view of the drawback of the prior technique, a primary objective of the present invention is to provide a portable multimedia device that can display at least two different channels for viewers' selection.

Another objective of the present invention is to provide a portable multimedia device that allows for users' preview of multiple channels for selection.

In order to achieve the above and other objectives, the present invention discloses a portable multimedia device capable of remotely controlling and receiving TV signals transmitted from a display device, the portable multimedia device consisting of a transmission interface, a display unit, a page-dividing unit and a selecting unit.

The page-dividing unit allows the user to set the number of desired channels for preview, and further divide a picture displayed on the display unit into a plurality of sub-pictures.

The selecting unit allows the user to select desired channels from the plurality of sub-pictures, and further display the selected channel on a display device or the display unit thereof, thereby concurrently providing at least two different channels thereon for users' preview as required.

The display device further comprises a TV card configured to receive TV signals and further convert the received signal to a TV signal of low resolution.

The page-dividing unit further comprises a function of ascertaining the number of channels for preview set by the user, and when the number of channels for preview is more than one, further generating a channel group signal and outputting the channel group signal via a transmission interface to the TV card, which then converts the received TV signal into a plurality of TV signals of low resolution according to the channel group signal, and further transmits the TV signals to the transmission interface via the wireless transmission system, for allowing channel pictures corresponding to the TV signals of low resolution to be displayed sequentially in the order of channels in a plurality of sub-pictures on the display unit. Meanwhile, the other channel pictures that are not currently being displayed are then divided according to the order and number of the channels set by the user, so as to be able to display the non-displayed pictures in a plurality of sub-pictures on other pages by operating the selecting unit.

The selecting unit further allows the user to choose directly the channels he/she wishes to view, and, after selecting a desired channel, a channel signal is generated and transmitted via the transmission interface to the TV card, for enabling a channel picture corresponding to the channel signal to be displayed on the display unit of the portable multimedia device.

The selecting unit further allows the user to choose directly the channels he/she wishes to view, and, after selecting a desired channel, a channel signal is generated and transmitted via the transmission interface to the TV card, which then converts the received TV signal into a TV signal of low resolution for transmitting to the transmission interface via the wireless transmission function, thereby allowing the display unit to display a channel picture corresponding to the low resolution TV signal.

The selecting unit further allows the user to choose directly the channels he/she wishes to view, and, after selecting a desired channel, a channel signal is generated and transmitted via the transmission interface to the TV card, which displays a corresponding channel picture on the display unit, and further concurrently converts the received TV signal to a TV signal of low resolution to be transmitted to the transmission interface via the wireless transmission function, thereby allowing the display unit to display a channel picture corresponding to the low-resolution TV signal.

The selecting unit may be a liquid crystal display; LCD.

The selecting unit may include a keystroke or a keyboard.

The selecting unit further permits users to select one of the channel pictures displayed in the plurality of sub-pictures on the display unit, and further enlarges the selected picture to a full-screen picture adapted to the display unit.

The selecting unit may be integrated with the display unit in the form of, for example, a liquid crystal display with a touch-sensitive screen (touch-screen).

The portable multimedia device further comprises a recording unit electrically connected to the selecting unit and the page-dividing unit, for allowing users to record therein pictures of TV programs as desired, and a storage unit electrically connected to the recording unit for allowing users to store therein channel pictures recorded by the recording unit.

The storage unit is a Non-Volatile Memory, NVM.

The portable multimedia device further comprises a first amplifier electrically connected to the selecting unit and the page-dividing unit to play sound according to the TV signal of low resolution, wherein the first amplifier includes a speaker.

The selecting unit further permits the user to adjust the sound volume of the first amplifier as required.

The display device further comprises a second amplifier electrically connected to the TV card to play sound according to the TV signal, wherein the second amplifier also includes a speaker.

The selecting unit further permits the user to adjust the sound volume of the second amplifier as required.

In summary, the present invention is characterized by the use of a page-dividing unit for allowing users to set the number of channels for preview and further dividing the picture shown on the display unit into a plurality of sub-pictures, and a selecting unit for users to select a desired channel from the plurality of sub-pictures for displaying on the display device and/or the display unit thereof, thereby providing at least two different channels for users' preview and watching.

### BRIEF DESCRIPTION OF DRAWINGS

The portable multimedia device apparatus of the present invention can be fully understood by reading the following detailed description of the preferred embodiment, with reference made to the accompanying drawings, wherein:

FIG. 1 is a block diagram illustrating a first preferred embodiment of the portable multimedia device according to the present invention; and

FIG. 2 is a perspective view illustrating the preferred embodiment of the portable multimedia device according to the present invention shown in the block diagram of FIG. 1.

### DETAILED DESCRIPTION OF PREFERRED EMBODIMENT

The present invention is described in the following so that one skilled in the pertinent art can readily understand other advantages and effects of the present invention. The present invention may also be implemented and applied according to other embodiments, and the details may be modified based on different views and applications without departing from the spirit of the invention.

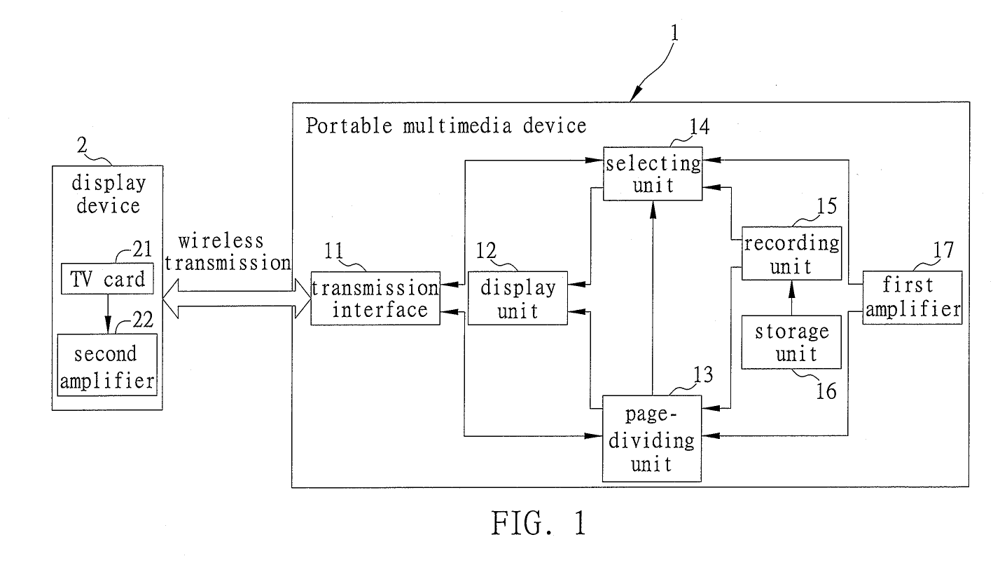

FIG. 1 is a block diagram depicting a first preferred embodiment of the portable multimedia device 1 according to the invention. The portable multimedia device 1 is capable of controlling and receiving TV signals transmitted from a display device 2 via a wireless transmission function thereof, wherein the display device 2 comprises a TV card 21 electrically connected to a second amplifier 22 for receiving TV signals and converting the received signal into a TV signal of low-resolution. The second amplifier 22 is a speaker adapted to play sound according to the TV signal.

The portable multimedia device 1 consists of a transmission interface 11, a display unit 12 with a screen, a page-dividing unit 13, a selecting unit 14, a recording unit 15, a storage unit 16, and a first amplifier 17.

The transmission interface 11 is designed to correspond to the wireless communication interface for the wireless transmission function of the display device 2 having a TV card 21 provided therein.

The display unit 12 may be, for example, a liquid crystal display (LCD).

The page-dividing unit 13 allows the user to set the number of desired channels for preview, and further divides the screen of the display unit 12 into a plurality of sub-screens, each capable of displaying a small but complete, independent picture or video.

The page-dividing unit 13 may use individual keys or a keyboard or some kind of touch-sensitive or motion-sensitive mechanism.

The selecting unit 14 allows the user to select desired channels from the plurality of channels displayed on the sub-screens, and further displays selected channels on the display device 2 or the display unit 12, thereby providing at least two different channels thereon for users' preview and selection as desired.

The selecting unit 14 may use individual keys or a keyboard or some kind of touch-sensitive or motion-sensitive mechanism.

The selecting unit 14 is electrically connected to the transmission interface 11, the display unit 12, and the page-dividing unit 13, for allowing users to directly choose the channel(s) he/she wishes to view from the channels displayed on the plurality of sub-screens, and, after selecting a desired channel, a channel signal is generated and transmitted via the transmission interface 11 to the display unit 2 and/or the display unit 12 to thereby display a corresponding channel picture thereon.

The selecting unit 14 further allows the user to choose directly the channels he/she wishes to view, and, after selecting a desired channel, a channel signal is generated and transmitted via the transmission interface 11 to the TV card 21, which then converts a corresponding received TV signal into a TV signal of low-resolution for transmitting to the transmission interface 11 via the wireless transmission function, thereby allowing the display unit 12 to display a channel picture corresponding to the low-resolution TV signal. The selecting unit 14 further allows the user to directly choose the channels he/she wishes to view, and, after selecting a desired channel, a channel signal is generated and transmitted via the transmission interface 11 to the TV card 21, which displays a channel picture corresponding to the channel signal on the display device 2 and further concurrently converts the received TV signal to a TV signal of low-resolution for transmitting to the transmission interface 11 via the wireless transmission function, thereby allowing the display unit 12 to display a channel picture corresponding to the low-resolution TV signal.

The selecting unit 14 further allows users to select one of the channel pictures displayed on the plurality of sub-screens of the display unit 12, and further enlarges the selected picture to a full-screen picture adapted to the display unit 12.

The selecting unit 14 may be integrated with the display unit 12 in the form of, for example, a liquid crystal display with a touch-sensitive panel (touch-screen), and may directly form a numeric keyboard or a hand-writing area on the touch-screen for allowing users to input their choices by pressing thereon or hand-writing the numbers of the channels for preview, thereby selecting channels from the display device 2 and/or the display unit 12 thereof for display. The selecting unit 14 also permits users to adjust sound volume of the second amplifier 22 as required.

The page-dividing unit 13 further comprises, after the user finishes setting the number of channels for preview, determining whether the number of channels for preview is more than one, and, if yes, generating a channel group signal and outputting the channel group signal via the transmission interface 11 to the TV card 21, which then converts the received TV signal into a plurality of TV signals of low-resolution according to the channel group signal, and further transmits the TV signal to the transmission interface 11 via the wireless transmission system, for allowing channel pictures corresponding to the TV signals of low-resolution to be displayed sequentially in the order of channels in a plurality of sub-screens on the display unit 12, wherein, any other channel pictures that are not currently being displayed are then divided according to the order and number of channels set by the user, so as to be able to display the non-displayed pictures in a plurality of sub-screens on one or more additional selectable pages by operating the selecting unit 14.

The recording unit 15 is electrically connected to the page-dividing unit 13 and the selecting unit 14, for allowing users to record pictures of TV programs as required. In this embodiment, the recording unit 15 may comprise a time-setting recording mode and/or a real-time recording mode, or both.

The storage unit 16 is electrically connected to the recording unit 15 for allowing users to store channel pictures recorded (selected, scheduled, written and/or processed) by the recording unit 15, wherein the storage unit 16 is a fixed or removable Non-Volatile Memory, NVM, or both.

The first amplifier 17 is electrically connected to the selecting unit 14 and the page-dividing unit 13 and adapted to play sound according to the TV signal of low-resolution, wherein the first amplifier 17 is a speaker and the selecting unit 14 further permits the user to adjust sound volume of the first amplifier 17 as required.

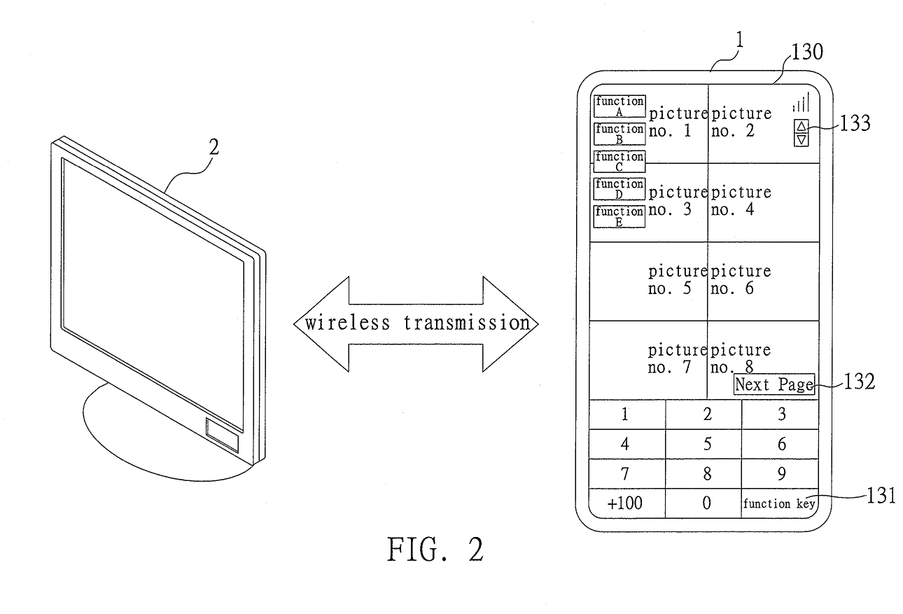

An operative example is provided in FIG. 2 to illustrate the theory, efficacy and features of the present invention. As shown, the portable multimedia device 1 is capable of controlling and receiving TV signals transmitted from a display device 2 such as an LCD via the wireless transmission function, wherein the display device 2 comprises a TV card 21 electrically connected to a second amplifier 22 for receiving one or more TV signals and converting the received signals into a TV signal of low resolution. The second amplifier 22 is a speaker adapted to play sound according to the TV signal

To change to a desired channel on the display device 2, the user only needs to press a function key 131 on the touch-screen 130 (in which the display unit 12 and the selecting unit 14 of the portable multimedia device 1 are integrated) to display five function items thereon: function A, function B, function C, function D and function E. Then, after the user presses function A and then one or more of the subsequently displayed numeric keys on the touch-screen 130 to choose a desired channel number (no. 26 for example), a channel signal is correspondingly generated and transmitted through the transmission interface 11 to the TV card 21, thereby allowing the display device 2 to display a channel picture corresponding to the selected channel number, channel 26, according to the channel signal received by the TV card 21.

If the user wishes to view a second channel on the display unit 12 of the portable multimedia device 1 at the same time as a first channel on the display device 2, he/she may press again function key 131 on the touch-screen 130 to display the five function items thereon: function A, function B, function C, function D and function E. Then, after the user presses function B (instead of function A) and then the numeric keys subsequently displayed on the touch-screen 130 to choose a desired channel number (such as no. 30), possibly for preview, a channel signal is correspondingly generated and transmitted through the transmission interface 11 to the TV card 21, which then converts the received TV signal to a TV signal of low-resolution for transmitting to the transmission interface 11 via the wireless transmission function thereof, thereby allowing the touch-screen 130 of the portable multimedia device 1 to display a channel picture corresponding to channel number 30 according to the low-resolution TV signal.

Similarly, function C, which is one of the five functions displayed on the touch-screen 130, is provided to allow users to watch the same channel on both the display device 2 and the portable multimedia device 1 at the same time if so desired. The operative mode is similar to the steps described above and will not be detailed herein for brevity.

When the user wishes to view a variety of channels on the portable multimedia device 1 at the same time, he/she may press again the function key 131 for the liquid touch control screen 130 to display the five function items A-E thereon. After the user presses function D, the number of channels for preview can be set by the numeric keys and displayed on the touch-screen 130. For example, when eight (8) is set by the user as the desired number of channels for preview, the page-dividing unit 13 of the portable multimedia device 1 proceeds to determine whether the number of channels is more than one, and, concurrently, a channel group signal is generated and transmitted through the transmission interface 11 to the TV card 21, which then converts multiple received TV signals to a TV signal of low-resolution for transmitting to the transmission interface 11 via the wireless transmission function, for allowing the page-dividing unit 13 to divide the screen of the touch-screen 130 into eight (8) sub-screens according to the number of channels set by the user for preview. Subsequently, the page-dividing unit 13, according to the order of channels, displays a plurality of pictures (from channel no. 1 to channel no. 8, for example) corresponding to the TV signal of low-resolution in the eight (8) sub-screens (picture no. 1 to picture no. 8 as illustrated in FIG. 2) on the touch-screen 130, and further divides any remaining channel pictures (for example, pictures after channel no. 8), and, according to the order of channels, distributes the remaining pictures (the channel pictures after channel no. 8, for example) to be the sub-screens of another page, selectable for viewing. Also, there is provided a page-selecting key 132 for displaying a “Next Page” on the lower-right side of the touch-screen 130 for the user's operation. Note that the mode of displaying pages can also be shown by using digits “1, 2, 3 . . . ” and is not limited to the page-selecting key 132 as disclosed above. Furthermore, the user may directly choose channel six (6) if he/she wishes to view only channel 6 on the portable multimedia device 1, so that the touch-screen 130 can directly enlarge the picture of channel 6 to a full-screen picture for viewing.

Alternatively, the user may press function D and, after setting the number of channels, press a function key 131 and then function A, and lastly choose directly one of the plurality of sub-pictures shown on the touch-screen 130 in order to select a desired channel on the display unit 2. Similarly, the user may press function D and, after setting the number of channels, press a function key 131 and then function A, and lastly choose directly one of the plurality of sub-screens shown on the touch-screen 130, so as to select a desired channel on both the display device 2 and the display unit 12. The operative theory of TV signals is the same as that described above and will not be further detailed herein for brevity.

Further, the user may press the function key 131 when he/she wishes to record a TV program and then further press function E, which is one of the five functions displayed on the touch-screen 130, thereby setting a desired mode of recording that includes a time-setting recording or a real-time recording, to further store channel video in the Non-Volatile Memory (NVM) for subsequent portable viewing according to users' preferences at any location desired.

In addition, when the user wishes to adjust the speaker volume of the portable multimedia device 1 or the display device 2, a touch-control type volume-adjusting key 133 is provided on the upper-right side of the touch-screen 130 for the adjustment of sound volume.

In conclusion, the characteristic of present invention is the provision of a page-dividing unit that allows users to set the number of channels for preview and further divides the screen of the display unit into a plurality of sub-screens for convenient and direct channel selection, as well as a selecting unit for users to select a desired channel from the plurality of sub-screens displayed on the display device and/or the display unit thereof, thereby providing control and viewing of at least two different channels for users' preview and/or watching as desired.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A portable multimedia device capable of remotely controlling and receiving TV signals transmitted from a display device, comprising:
a transmission interface;
a display unit having a screen;
a page-dividing unit for allowing a user to set the number of desired channels for preview, and further dividing the screen of the display unit into a plurality of sub-screens, each capable of displaying a reduced-size picture; and
a selecting unit for allowing the user to select desired channels from the plurality of sub-screen pictures, and further displaying the selected channel on a display device and/or the display unit, thereby concurrently providing at least two different channels thereon for users' preview or viewing as desired.

2. The portable multimedia device of claim 1, wherein the display device further comprises a TV card configured to receive TV signals and further convert the received signal to a TV signal of low-resolution.

3. The portable multimedia device of claim 2, wherein the page-dividing unit further comprises a function of determining the number of channels for preview set by the user, and, when the number of channels for preview is more than one, further generating a channel group signal and outputting the channel group signal via a transmission interface to the TV card, which then converts the received TV signals into a plurality of TV signals of low-resolution according to the channel group signal and further transmits the TV signals to the transmission interface via the wireless transmission system, for allowing channel pictures corresponding to the TV signals of low-resolution to be displayed sequentially in the order of channels on a plurality of sub-screens of the display unit, wherein any other channel pictures that are not currently displayed are then divided according to the order and number of the channels set by the user, so as to display the non-displayed channel pictures in a plurality of sub-pictures on additional pages by operating the selecting unit.

4. The portable multimedia device of claim 2, wherein the selecting unit further allows the user to choose directly the channels he/she wishes to view, and, after selecting a desired channel, a channel signal is generated and transmitted via the transmission interface to the TV card, thereby displaying a corresponding channel picture on the display device.

5. The portable multimedia device of claim 2, wherein the selecting unit further allows the user to choose directly the channels he/she wishes to view, and, after selecting a desired channel, a channel signal is generated and transmitted via the transmission interface to the TV card, which then converts the received TV signal into a TV signal of low-resolution for transmitting to the transmission interface via the wireless transmission function, thereby allowing the display unit of the portable multimedia device to display a channel picture corresponding to the low-resolution TV signal.

6. The portable multimedia device of claim 2, wherein the selecting unit further allows the user to choose directly the channels he/she wishes to view, and, after selecting a desired channel, a channel signal is generated and transmitted via the transmission interface to the TV card, which displays a corresponding channel picture on the display device, and further concurrently converts the received TV signal into a TV signal of low-resolution for transmitting to the transmission interface via the wireless transmission function, thereby allowing the display unit of the portable multimedia device to display a channel picture corresponding to the low-resolution TV signal.

7. The portable multimedia device of claim 1, wherein the selecting unit may be one of a liquid crystal display (LCD), organic light-emitting diode (OLED) display, and the like.

8. The portable multimedia device of claim 1, wherein the selecting unit may include individual keys, a keyboard, touch-sensitive mechanisms, and motion-sensing mechanisms.

9. The portable multimedia device of claim 1, wherein the selecting unit further permits users to select one of the channel pictures displayed on the plurality of sub-screens of the display unit, and further enlarges the selected picture to a full-screen picture adapted to the display unit.

10. The portable multimedia device of claim 9, wherein the selecting unit may be integrated with the display unit in the form of a liquid crystal display combined with a touch-pad known as a touch-screen.

11. The portable multimedia device of claim 1, wherein the page-dividing unit may include individual keys, a keyboard, touch-sensitive mechanisms, and motion-sensing mechanisms.

12. The portable multimedia device of claim 1, further comprising
a recording unit electrically connected to the selecting unit and the page-dividing unit, for allowing users to record pictures of TV programs as desired; and
a storage unit electrically connected to the recording unit for allowing users to store therein channel pictures recorded by the recording unit.

13. The portable multimedia device of claim 12, wherein the recording unit may comprise a time-setting recording mode and/or a real-time recording mode, or both.

14. The portable multimedia device of claim 12, wherein the storage unit is a non-volatile memory (NVM).

15. The portable multimedia device of claim 1, wherein the portable multimedia device further comprises a first amplifier electrically connected to the selecting unit and the page-dividing unit for playing sound according to the TV signal of low-resolution received from the display device or stored in the non-volatile memory.

16. The portable multimedia device of claim 15, wherein the selecting unit further permits the user to adjust a volume of the sound of the first amplifier as required.

17. The portable multimedia device of claim 15, wherein the first amplifier is a speaker.

18. The portable multimedia device of claim 2, wherein the display device further comprises a second amplifier electrically connected to the TV card for playing sound according to the TV signal.

19. The portable multimedia device of claim 18, wherein the selecting unit further permits the user to adjust the sound volume of the second amplifier as required.

20. The portable multimedia device of claim 18, wherein the second amplifier is a speaker.
